(19) United States
(12) Patent Application Publication
(10) Pub. No.: US 2008/0100259 A1
(43) Pub. Date: May 1, 2008

(54) SERVICE JUMP-START DEVICE FOR HYBRID ELECTRIC VEHICLES

(75) Inventor: Benjamin A. Tabatowski-Bush, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 11/553,214

(22) Filed: Oct. 26, 2006

(51) Int. Cl. H02J 7/00

(52) U.S. Cl. 320/104

(57) ABSTRACT

A hybrid electric vehicle includes an internal combustion engine, a traction battery, and a hybrid electric powertrain. A compact, portable, off board service jump-start device provides direct current (DC) power at a proper voltage and current to recharge the traction battery. The device includes a power supply with a high voltage output for providing the DC power. The device further includes a communication interface for receiving commands to control the recharging of the traction battery. The power supply recharges the traction battery in accordance with the received commands. Advantageously, this provides a compact, portable, off board service jump-start device that provides a controlled recharging of the traction battery of the hybrid electric vehicle and allows charging of the traction battery without the need for charging circuits on the vehicle.

### BACKGROUND OF THE INVENTION

1. Field of the Invention

The invention relates to hybrid electric vehicles of the type including an internal combustion engine, a traction battery, and a hybrid electric powertrain. The invention further relates to recharging the traction battery in a circumstance where the traction battery gets over discharged.

2. Background Art

In an existing hybrid electric vehicle, a hybrid electric vehicle powertrain includes a vehicle system controller (VSC), an internal combustion engine, a traction battery, and a transmission including a motor-generator subsystem. These components form a power split powertrain, and the VSC may control the components in an attempt to maximize fuel economy.

It is possible that, under some circumstances, the traction battery may get over discharged, making it impossible to start the engine using the traction battery.

There are some existing techniques for recharging a traction battery of a hybrid electric vehicle. Typically, the circuits required to recharge the traction battery are mounted to the vehicle, with sub-optimal controls or no controls at all in the recharging process.

Background information may be found in U.S. Pat. Nos. 5,202,617; 5,349,535; 5,548,200; 5,594,318; 5,670,861; 6,225,776; 6,614,204; and 6,917,180.

### SUMMARY OF THE INVENTION

In accordance with the invention, a service jump-start device for hybrid electric vehicles is provided. The service jump-start device is a compact, portable, off board box which provides direct current (DC) power at the proper voltage and current to recharge the traction battery. In one implementation, the service jump-start device plugs into standard alternating current (AC) electric service, and inverts the AC power to provide DC power to a connected traction battery. Alternatively, the service jump-start device could use a different power source to provide the needed DC power to the traction battery. For example, a DC-to-DC convertor could provide the needed high voltage DC output for the traction battery from a lower voltage DC source (for example, 12 volts).

Embodiments of the invention have many advantages. For example, a service jump-start device made in accordance with the invention may allow a service organization/dealership or other automotive service business to recharge the traction battery without the need for charging circuits on the vehicle. The compact, portable, off board device is suitable for service applications, and avoids the cost and complexity of providing on board charging circuits and further avoids the rigidity of infrastructure intense approaches (for example, a street corner electrical service station).

At the more detailed level, the hybrid electric vehicle containing the traction battery further includes a battery energy control module (BECM). In accordance with the invention, the BECM works in conjunction with a battery pack sensor module (BPSM) or voltage, current, temperature sensing module (VITSM), and assures an optimal charge of the traction battery. The service jump-start device includes a power supply with a high voltage output (for example, 330 volts) for providing DC power to charge the battery, and a communication interface. The vehicle BECM commands the power supply through the communication interface to control recharging of the traction battery.

### BRIEF DESCRIPTION OF THE DRAWINGS

FIG. 1 is a schematic representation of a power split powertrain system configuration;

FIG. 2 is a schematic representation, in block diagram form, of a powertrain system power flow diagram;

FIG. 3 is a system diagram of the service jump-start device connected to the battery pack in accordance with a preferred embodiment of the invention; and

FIG. 4 is a block diagram illustrating the procedure for charging the traction battery with the service jump-start device in accordance with the preferred embodiment of the invention.

### DETAILED DESCRIPTION OF THE PREFERRED EMBODIMENT

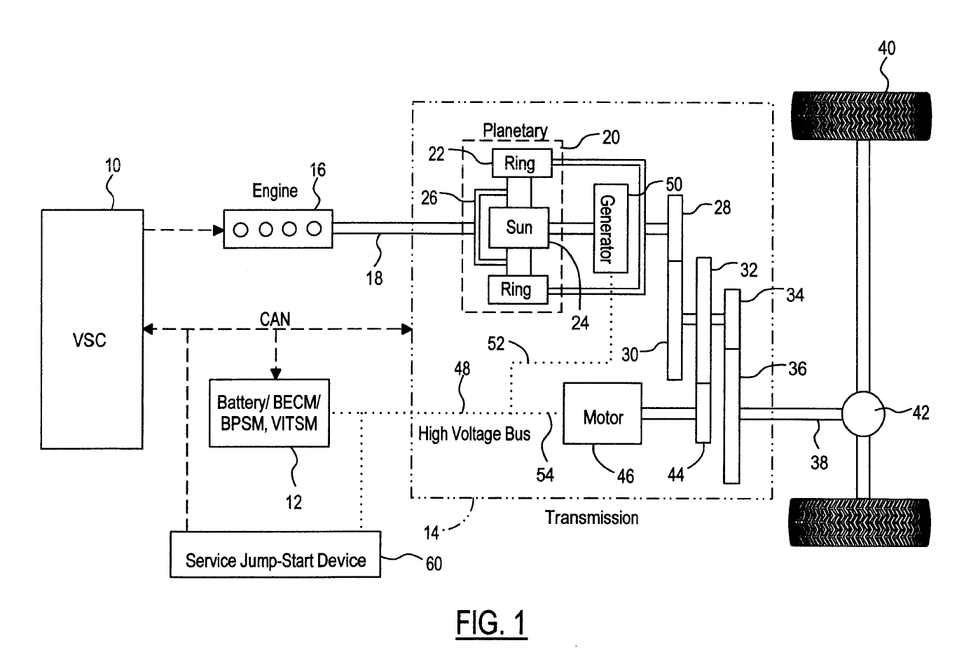

A hybrid electric vehicle powertrain is shown in FIG. 1. A vehicle system controller (VSC) 10, a battery and battery energy control module (BECM) 12, and a transmission 14, together with a motor-generator subsystem, comprise a control area network (CAN). An internal combustion engine 16, controlled by VSC 10, distributes torque through torque input shaft 18 to transmission 14.

The transmission 14 includes a planetary gear unit 20, which comprises a ring gear 22, a sun gear 24, and a planetary carrier assembly 26. The ring gear 22 distributes torque to step ratio gears comprising meshing gear elements 28, 30, 32, 34, and 36. A torque output shaft 38 for the transmission 14 is drivably connected to vehicle traction wheels 40 through a differential and axle mechanism 42.

Gears 30, 32, and 34 are mounted on a countershaft, with gear 32 engaging a motor-driven gear 44. Electric motor 46 drives gear 44, which acts as a torque input for the countershaft gearing.

The battery delivers electric power to the motor through power flow path 48, 54. Generator 50 is connected electrically to the battery and to the motor in a known fashion as shown at 52.

The power split powertrain system of FIG. 1 may be operated in a variety of different modes as is appreciated by those skilled in the art. As shown, there are two power sources for the drive line. The first power source is a combination of the engine and generator subsystems, which are connected together using the planetary gear unit 20. The other power source involves the electric drive system including the motor 46, the generator 50, and the battery, where the battery acts as an energy storage medium for the generator 50 and the motor 46.

In general, VSC 10 calculates the total engine power needed to meet the drive wheel power demand plus all accessory loads, and independently schedules the engine speed and load operating point, with or without feedback of actual engine performance, to meet the total power demand. This type of approach is typically used to maximize fuel economy and may be used in other types of powertrain systems that have such VSCs.

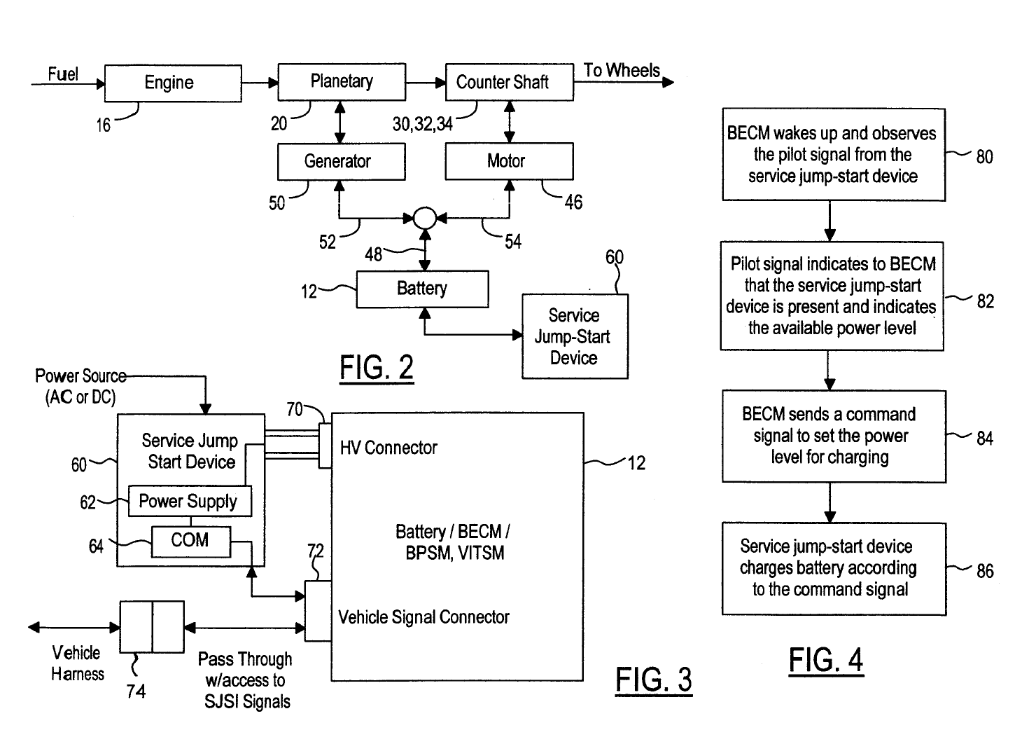

The power flow paths between the various elements of the power split powertrain diagram shown in FIG. 1 are illustrated in FIG. 2. Fuel is delivered to the engine 16 under the control of the operator in a known fashion using an engine throttle. Engine 16 delivers power to the planetary gear unit 20. The available engine brake power is reduced by accessory loads. Power is delivered by the planetary ring gear to the countershaft gears 30, 32, 34. Power output from the transmission drives the wheels.

Generator 50, when acting as a motor, can deliver power to the planetary gearing. When acting as a generator, generator 50 is driven by the planetary gearing. Similarly, power distribution between the motor 46 and the countershaft gears 30, 32, 34 can be distributed in either direction.

As shown in FIGS. 1 and 2, engine power output can be split into two paths by controlling generator 50. In operation, the system determines the driver's demand for torque and achieves the optimum split of power between the two power sources. There is the possibility that, under some circumstances, the traction battery may get over discharged. This situation makes it impossible to start the engine 16 using the traction battery. The vehicle does not include circuits for recharging the traction battery. In accordance with the invention, a service jump-start device 60 is a compact, portable, off board box for providing direct current (DC) power to recharge the traction battery.

FIG. 3 shows the service jump-start device 60 connected to the battery pack 12 in the preferred embodiment of the invention. Service jump-start device 60, when connected to a suitable power source, provides DC power at the proper voltage and current to recharge the traction battery. It is appreciated that service jump-start device 60 may plug into standard alternating current (AC) electric service, and invert the AC power to provide the required DC power to the connected traction battery. In one alternative, the power source for the service jump-start device 60 may be a DC power source with a DC-to-DC convertor providing the needed high voltage DC output for the traction battery. In any arrangement, the service jump-start device 60 is a compact, portable, off board device that provides DC power to recharge the traction battery, avoiding the cost and complexity of providing on board charging circuits, and avoiding the rigidity of infrastructure intensive approaches that are more suited for an electric vehicle as opposed to a hybrid electric vehicle (for example, a street corner electrical service station).

Service jump-start device 60 includes a power supply 62 with a high voltage output, and a communication interface 64. Power supply 62 connects to a high voltage connector 70 on the battery. A vehicle signal connector 72 on the battery connects to communication interface 64 of the service jump-start device 60, and connects to harness connector 74. The BECM works in conjunction with a battery pack sensor module (BPSM) or voltage, current, temperature sensing module (VITSM) and assures an optimal charge of the traction battery.

FIG. 4 illustrates using the service jump-start device 60 to recharge an over discharged traction battery in the preferred implementation of the invention. With reference to FIGS. 3 and 4, to recharge the traction battery, the service jump-start device 60 is connected to the high voltage connector 70 and the vehicle signal connector 72 of the battery energy control module (BECM) 12. The service jump-start device 60 provides a pilot signal to indicate its presence to the BECM 12. At block 80, the BECM 12 wakes up and observes the pilot signal from the service jump-start device 60.

As shown in block 82, this pilot signal indicates to the BECM 12 that the service jump-start device 60 is present and the pilot signal indicates the available power level or charging capability of the service jump-start device 60. In accordance with the invention, the BECM 12 controls charging. As shown at block 84, the BECM 12 sends a command signal to set the power level for charging. At block 86, the service jump-start device 60 charges the battery according to the command signal. In this way, the BECM 12 manages recharging of the battery by manipulating the power request sent to the service jump-start device 60, which is a compact, portable, off board device.

It is appreciated that a variety of approaches may be taken to implement the signaling between the service jump-start device and the BECM. Further, it is appreciated that embodiments of the invention have many advantages. For example, the compact, portable, off board device provides the required DC power to recharge the traction battery and may allow a service organization or dealership, or other automotive service business to recharge the traction battery without the need for charging circuits on the vehicle. Signal details an exemplary implementation of the invention described below.

### Signal Details

### SJSI Pilot SJSI_PILOT

This is the signal from the SJSI tool that provides information from the tool to the BECM. Proposed circuit: Open collector in SJSI with 100 ohm pullup in SJSI, 2.4 K pulldown in BECM to GND.
Type: PWM Input
Frequency: 1 kHZ
Valid Range: 10% to 90%
Voltage Range: 0-12V

### Drive Current: 5 mA max from SJSI

Voh 8V at 5 mA sourcing from SJSI
Vol 4V at 5 mA sinking into SJSI
   Signal Definition for duty cycle input:
<10% Wiring fault or SJSI tool not plugged in
10%-20% SJSI plugged in, but SJSI is faulted
20%-90% SJSI present and proper

20%—Zero power available

90%—Maximum power available
>90% Wiring fault

### SJSI Power Command SJSI_CMD

Type: PWM Output
Frequency: 1 kHz
Valid Range: 10% to 90%
Voltage Range: 0-12V
   Signal Definition for duty cycle output:
<10% Wiring fault or SJSI tool not plugged in
10%-20% BECM plugged into SJSI, indicated faulted system
20%-90% BECM present and proper

20%—requesting zero power

90%—requesting max power available
>90% Wiring fault

### SJSI Signal Ground SJSI_GND

### Signal ground reference provided to SJSI tool.

While the best mode for carrying out the invention has been described in detail, those familiar with the art to which this invention relates will recognize various alternative designs and embodiments for practicing the invention as defined by the following claims.

What is claimed:

1. A service apparatus for a hybrid electric vehicle including an internal combustion engine, a traction battery, and a hybrid electric powertrain, the apparatus comprising:
a compact, portable, off board service jump-start device for providing direct current (DC) power at a proper voltage and current to recharge the traction battery, the device including a power supply with a high voltage output for providing the DC power, the device further including a communication interface for receiving commands to control the recharging of the traction battery, wherein the power supply recharges the traction battery in accordance with the received commands, thereby providing a compact, portable, off board service jump-start device that provides a controlled recharging of the traction battery of the hybrid electric vehicle.

2. The apparatus of claim 1 wherein the device is configured to plug into a standard alternating current (AC) electric service and the power supply inverts this AC power to provide the DC power to a connected traction battery.

3. The apparatus of claim 1 wherein the device is configured to plug into a direct current (DC) power source and the power supply converts this DC power to provide the DC power to a connected traction battery.

4. The apparatus of claim 1 wherein the device is configured to send a pilot signal over the communication interface to indicate to a connected battery control module that the device is present.

5. The apparatus of claim 4 wherein the pilot signal is a pulse width modulated (PWM) signal.

6. The apparatus of claim 4 wherein the device is configured to receive a power command signal over the communication interface from the battery control module to indicate the requested power for charging the traction battery, wherein the device receives the power command signal after sending the pilot signal.

7. The apparatus of claim 6 wherein the power command signal is a pulse width modulated (PWM) signal.

8. The apparatus of claim 1 wherein the device is configured to receive a power command signal over the communication interface from a connected battery control module to indicate the requested power for charging the traction battery.

9. The apparatus of claim 8 wherein the power command signal is a pulse width modulated (PWM) signal.

10. A method of servicing a hybrid electric vehicle including an internal combustion engine, a traction battery, and a hybrid electric powertrain, the method comprising:
providing a compact, portable, off board service jump-start device for providing direct current (DC) power at a proper voltage and current to recharge the traction battery, the device including a power supply with a high voltage output for providing the DC power, the device further including a communication interface for receiving commands to control the recharging of the traction battery, wherein the power supply recharges the traction battery in accordance with the received commands, thereby providing a compact, portable, off board service jump-start device that provides a controlled recharging of the traction battery of the hybrid electric vehicle;
connecting the service jump-start device to the traction battery; and
charging the traction battery with the service jump-start device.

11. The method of claim 10 further comprising:
plugging the device into a standard alternating current (AC) electric service, the power supply inverting this AC power to provide the DC power to the connected traction battery.

12. The method of claim 10 further comprising:
plugging the device into a direct current (DC) power source, the power supply converting this DC power to provide the DC power to the connected traction battery.

13. The method of claim 10 wherein the device is configured to send a pilot signal over the communication interface to indicate to a connected battery control module that the device is present.

14. The method of claim 13 wherein the pilot signal is a pulse width modulated (PWM) signal.

15. The method of claim 13 wherein the device is configured to receive a power command signal over the communication interface from the battery control module to indicate the requested power for charging the traction battery, wherein the device receives the power command signal after sending the pilot signal.

16. The method of claim 15 wherein the power command signal is a pulse width modulated (PWM) signal.

17. The method of claim 10 wherein the device is configured to receive a power command signal over the communication interface from a connected battery control module to indicate the requested power for charging the traction battery.

18. The method of claim 17 wherein the power command signal is a pulse width modulated (PWM) signal.

19. A service apparatus for a vehicle including a traction battery, the apparatus comprising:
a compact, portable, off board service jump-start device for providing direct current (DC) power at a proper voltage and current to recharge the traction battery, the device including a power supply with a high voltage output for providing the DC power, the device further including a communication interface for receiving commands to control the recharging of the traction battery, wherein the power supply recharges the traction battery in accordance with the received commands, thereby providing a compact, portable, off board service jump-start device that provides a controlled recharging of the traction battery of the vehicle.

20. The apparatus of claim 19 wherein the device is configured to receive a power command signal over the communication interface from a connected battery control module to indicate the requested power for charging the traction battery.
